(19) United States
(12) Patent Application Publication
(10) Pub. No.: US 2025/0161854 A1
(43) Pub. Date: May 22, 2025

(54) COALESCING FILTER ELEMENT AND FILTER SYSTEM

(71) Applicant: INDUFIL BV, Duiven (NL)

(72) Inventors: Jasper Oranje, Duiven (NL); Thomas Doerfler, Duiven (NL)

(21) Appl. No.: 18/695,169

(22) PCT Filed: Sep. 23, 2022
(86) PCT No.: PCT/IB2022/000555

§ 371 Date: Mar. 25, 2024

(30) Foreign Application Priority Data
Sep. 24, 2021 (GB) 2113668.4

(51) Int. Cl. B01D 46/00; B01D 17/00; B01D 17/04; B01D 46/24

(52) U.S. Cl. CPC B01D 46/003; B01D 17/045; B01D 17/10; B01D 46/0005; B01D 46/0043; B01D 46/24; B01D 2265/021; B01D 2265/028

(57) ABSTRACT

An aspect of the disclosure provides a coalescing filter element configured for installation into a filter system for filtering a multiphasic fluid, wherein the multiphasic fluid comprises a first phase entrained in a second phase, wherein the coalescing filter element comprises: a filter medium configured to: coalesce particles of the first phase to provide coalesced particles comprising the first phase to enable separation of the coalesced particles from the second phase; a collar connected to the filter medium, wherein the collar is configured to: hold the filter medium in a predefined shape; and, engage with an annular holder of a mounting assembly of the filter system to permit installation of the coalescing filter element into the filter system; wherein the collar comprises: a collar anti-rotation element configured to engage the annular holder thereby to prevent or reduce at least one of: (a) rotation of the collar relative to the holder; and, (b) vibration of the collar relative to the holder.

### TECHNICAL FIELD

The present disclosure relates generally to methods and apparatus, and more particularly to coalescing filter elements for filtering multiphasic fluid wherein the multiphasic fluid comprises a first phase entrained in a second phase, mounting assemblies configured to engage coalescing filter elements, and filter systems.

### BACKGROUND

In a number of industries there is a need to provide clean flow of fluid particular where hydrocarbons might be contaminated with polar solvents (e.g. water).

It is a significant problem to provide excessive throughout without excessive pressure drop.

Maintaining the systems is difficult particularly where throughput is very high, the process is very sensitive, the process is very expensive, and maintenance interruptions undesirable.

Components need to be highly reliable and can be swiftly and easily interchanged.

### SUMMARY

Aspects of the invention are set out in the independent claims and optional features are set out in the dependent claims and aim to address the above described technical problems, and related problems. Aspects of the disclosure may be provided in conjunction with each other, and features of one aspect may be applied to other aspects.

An aspect of the disclosure provides a coalescing filter element configured for installation into a filter system for filtering a multiphasic fluid, wherein the multiphasic fluid comprises a first phase entrained in a second phase, wherein the coalescing filter element comprises: a filter medium configured to: coalesce particles of the first phase to provide coalesced particles comprising the first phase to enable separation of the coalesced particles from the second phase; a collar connected to the filter medium, wherein the collar is configured to: hold the filter medium in a predefined shape; and, engage with an annular holder of a mounting assembly of the filter system to permit installation of the coalescing filter element into the filter system; wherein the collar comprises: a collar anti-rotation element configured to engage the annular holder thereby to prevent or reduce at least one of: (a) rotation of the collar relative to the holder; and, (b) vibration of the collar relative to the holder.

Embodiments of the disclosure may increase the lifetime of the collar and/or holder.

In examples, the collar is fixedly attached to the filter medium. Therefore, in such examples, prevention or reduction of rotation of the collar relative to the holder necessarily results in a corresponding prevention or reduction of rotation of the filter medium (and the coalescing filter element as a whole) relative to the holder.

The collar anti-rotation element may be configured to hold the filter medium in a predefined rotational position with respect to the holder when the coalescing filter element is installed in the filter system.

The predefined shape may be a cylinder having a longitudinal axis; and, the collar anti-rotation element may be configured to engage the holder by longitudinal movement of the coalescing filter element toward the holder wherein the collar anti-rotation element once engaged with the collar thereby inhibits rotation of the coalescing filter element about the longitudinal axis.

In use, a predominantly lateral flow of the multiphasic fluid may be provided through the filter medium, which exerts one of: a lateral force; and, torsional force on the coalescing filter element; and, the wherein collar anti-rotational element configured to engage the holder to resist said force.

In examples, rotation of a coalescing filter element can be caused by the multiphasic fluid passing through the coalescing filter element e.g. the multiphasic fluid exerts a lateral and/or torsional force(s) on the coalescing filter element. The collar anti-rotation element of the present disclosure is configured to engage an annular holder to reduce or prevent such rotations e.g. the collar anti-rotation element may engage the holder by means of an interference/transition fit, and the forces causing the rotations of the coalescing filter element may be smaller than the force required to remove the interference/transition fit.

In examples, vibration of a coalescing filter element can be caused by the multiphasic fluid passing through the coalescing filter elements and/or vibrations in other parts of the filter system which are transmitted to the coalescing filter element. The collar anti-rotation element of the present disclosure is configured to engage an annular holder to reduce or prevent such vibrations e.g. the collar anti-rotation element may engage the holder by means of an interference fit, and the forces causing the vibrations of the coalescing filter element may be smaller than the force required to remove the interference fit.

The coalescing filter element may comprise an L/D ratio (e.g. a length-diameter ratio), defined as the diameter of the internal passage divided the longitudinal length of the coalescing filter element (for example, the longitudinal length may refer to the length of a filter media of the coalescing filter element), wherein the L/D ratio may be between, for example, 3.0 and 6.0, for example, the L/D ratio may be between 3.5 and 5.1, for example, the L/D ratio is between 3.2 and 4.8.

Advantageously, providing a coalescing filter element with an L/D ratio is between any of 3.0 and 6.0, 3.5 and 5.1, or 3.2 to 4.8 may provide a maldistribution percentage at or below 45%. The maldistribution may be defined as the ratio of the ‘ideal velocity’ and the ‘real velocity’. For example, the maldistribution may be defined as:

Maldistribution=1−real velocity/ideal velocity

Maldistribution percentage=[1−(real velocity/ideal velocity)]×100%

Herein the ideal velocity may also be referred to as the superficial velocity. The ideal velocity may be defined as the volume flow through the filter element divided by the total external surface area of the filter element. The ideal velocity may be used in empirical models. The real velocity may be defined as the actual volume flow through the filter (e.g. measured volume flow through the filter) divided by the total external surface area of the filter element. The degree of agreement between the ideal velocity and the real velocity is indicative of efficiency of a filter element e.g. the closer the maldistribution is to zero the greater the efficiency.

A greater maldistribution may result in a greater number of small particles (e.g. solids) passing through the filter element (e.g. not being filtered). A greater maldistribution may result in a greater number of particles of the first phase being reentrained in the second phase.

The coalescing filter element may comprise an L/D ratio, defined as the diameter of the internal passage divided the longitudinal length of the coalescing filter element, wherein the L/D ratio is between 3.2 and 4.8. Advantageously, filter elements having an L/D ratio in this range may have a low maldistribution which may reduce separation efficiency and, therefore, may provide an improved separation efficiency.

The coalescing filter element may comprise an L/D ratio, defined as the diameter of the internal passage divided the longitudinal length of the coalescing filter element, wherein the L/D ratio is between 3.5 and 5.1. Advantageously, filter elements having an L/D ratio in this range have an improved throughput which may provide an improved separation efficiency.

Computational Fluid Dynamics (CFD) simulations performed by the inventors have shown that a portion of the surface area of filter element receives a smaller flow volume therethrough. In examples wherein the filter element has a cylindrical shape and an inlet at a first end (e.g. a bottom end of the filter element) the flow rate through a radial part of the filter element decreases as an axial distance from the first end increases e.g. more fluid (e.g. gas) flows out of the filter element closer to the first end; e.g. the fluid flow is concentrated close to the first end. In such examples, the bulk velocity (the velocity of majority of the gas) is higher than the ideal velocity. When the bulk velocity is higher than the ideal velocity then there is a negative influence on the separation of the smallest particles/droplets.

The coalescing filter element may comprise an internal passage. For example, the internal passage may be provided, in part, by the filter medium (e.g. an internal passage of the filter medium) and, in part, by the collar (e.g. an internal passage of the collar, in fluid communication with the internal passage of the filter medium). The internal passage of the collar and an outlet of the holder may be configured engage by means of an interference fit or a transition fit between the internal passage and the outlet of the holder.

Advantageously, rotation and/or vibrations of the coalescing filter element relative to a holder of mounting assembly may be prevented. For example, the internal passage of the collar may comprise the collar anti-rotation element. For example, the engagement between the internal passage of the collar and an outlet of the holder (e.g. by interference/transition fit) may be prevent or reduce vibration and/or rotation of the collar relative to the coalescing filter element.

For example, the diameter of the internal passage may be selected to provide an engagement between the outlet of the holder.

The collar anti-rotation element may comprise at least one of: a projection and a recess configured to engage with a corresponding complementary element of the holder.

In examples wherein the collar anti-rotation element comprises a projection (e.g. a collar projection) the complementary element of the holder may comprise a recess (e.g. a holder recess), wherein the recess is configured to receive the projection.

In examples wherein the collar anti-rotation element comprises a recess (e.g. a collar recess) the complementary element of the holder may comprise a projection (e.g. a holder projection), wherein the recess is configured to receive the projection.

In examples wherein the collar anti-rotation element comprises both a projection and a recess (e.g. a collar projection and a collar recess), the complementary element of the holder may comprise a projection and a recess (e.g. a holder projection and a holder recess). In such examples, the collar recess is configured to receive the holder projection and the holder recess is configured to receive the collar projection.

In examples wherein the collar anti-rotation element comprises both a recess and a projection, the torque on the projection of the collar anti-rotation element may be reduced because there is also projection of the holder anti-rotation element which may act to spread the torsion and or strain applied to the system.

In some examples, the collar projection may have a different cross-sectional shape (e.g. collar projection cross-sectional shape) may differ from that of the collar recess (e.g. collar recess cross-sectional shape). The holder projection may have a corresponding cross-sectional shape (e.g. holder projection cross sectional shape) to the collar recess cross-sectional shape). The holder recess may have a corresponding cross-sectional shape (e.g. holder recess cross-sectional shape) to the collar projection cross-sectional shape).

One of the collar projection or collar recess cross-sectional shapes may have a greater efficacy at preventing/reducing vibrations than other cross-sectional shapes e.g. a circle cross-sectional shape may have a greater efficacy at preventing/reducing vibrations than a square cross-sectional shape.

One of the collar projection or collar recess cross-sectional shapes may have a greater efficacy at preventing/reducing rotations of the collar relative to the holder than other cross-sectional shapes e.g. a square cross-sectional shape may have a greater efficacy at preventing/reducing such rotations than a circle cross-sectional shape.

Advantageously, providing two different cross-sectional shapes (e.g. a collar projection with a cross-sectional shape which is a square and a collar recess with a cross-section shape which is a circle) may prevent/reduce both vibrations and rotations of the collar relative to the holder.

In examples, collar projection cross-sectional shape may be a square and the collar recess cross sectional shape may be a circle.

In examples, the collar recess may be surrounded by the collar projection. In such examples, the holder projection may be surrounded by the holder recess.

In examples, the collar projection may be surrounded by the collar recess. In such examples, the holder recess may be surrounded by the holder projection.

The projection and recess engage by any of: a transition fit, and an interference fit.

Advantageously, using a transition/interference fit may reduce the number of steps needed to engage the collar with a holder e.g. the projection may merely be forced into the recess. For example, other collar anti-rotation elements may comprise a clip which requires a number of actions/movements in order to engage the collar with the holder.

In examples, the projection may have a tapered portion.

In examples, the recess comprises a chamfered aperture.

Advantageously, providing projection with a tapered portion and/or a recess comprising a chamfered aperture may permit easier engagement of the collar anti-rotation element and holder (e.g. easier insertion of the projection into the recess).

The collar anti-rotation element may comprise a clip member configured to engage the holder.

The collar anti-rotation element comprising a clip member. Advantageously, existing holders on existing mounting assemblies may not require modification in order for the collar anti-rotation element to engage the holder. Accordingly, coalescing filter elements of the present disclosure may be engaged with holders of existing mounting assemblies and at least one of rotation and vibration of the collars relative the holders may be reduced or prevented by the anti-rotation element.

In examples, the clip member may clip over an edge of existing holders e.g. in the manner of snap-fit.

In examples, the holder may comprise a planar member (e.g. an annular bezel) having a first planar face (e.g. for seating the coalescing filter element thereupon) and a second planar face opposite the first planar face. In such examples, the coalescing filter element is configured to engage the holder such that the filter medium. For example, to engage the holder, the clip member may be disposed one a first face of the planar member and at least part of the collar disposed on a second face of the planar member. In examples, the clip member may be biased towards at least part of the collar to thereby engage the planar member of the holder therebetween. In examples, the clip member is configured to engage the holder by means of a snap-fit.

In examples, the coalescing filter element may comprise a plurality of the collar anti-rotation elements. In such examples, the holder may comprise a plurality of holder anti-rotation elements (e.g. a corresponding number of holder anti-rotation elements to the collar anti-rotation elements).

An aspect of the disclosure provides mounting assembly of a filter system for filtering a multiphasic fluid, the filter system configured to permit installation of a coalescing filter element therein, wherein the multiphasic fluid comprises a first phase entrained in a second phase, wherein the mounting assembly comprises: one or more holders, wherein each of the one or more holders is configured to: engage a collar of a coalescing filter element to thereby prevent rotation of the coalescing filter element relative to a holder.

Embodiments of the disclosure may increase the lifetime of the collar and/or holder.

Preventing rotation and/or vibration may reduce or prevent the generation of particles due to wear. Advantageously, problems associated with particles generated from wear may be reduced or avoided.

The one or more holders may comprise a holder anti-rotation element configured to hold the filter medium in a predefined rotational position with respect to the holder when the coalescing filter element is installed on the mounting assembly.

The one or more holders may each be configured to engage a coalescing filter element, wherein the coalescing filter element may comprise: a filter medium with a cylindrical shape and a collar with an annular shape, wherein the filter medium and the collar share a longitudinal axis; and, the one or more holders are configured to engage the coalescing filter element by longitudinal movement of the coalescing filter element toward the one or more holders to install the coalescing filter element on the one or more holders.

In use, a predominantly lateral flow of the multiphasic fluid may be provided, via the one or more holders, through the filter medium of the coalescing filter element, which exerts one of: a lateral force; and, torsional force on the coalescing filter element; and, the wherein collar anti-rotational element configured to engage the holder to resist said force.

In examples, each holder anti-rotation element may comprise at least one of: a projection and a recess configured to engage a corresponding collar anti-rotation element. In examples, the projection may be tapered. In examples, the recess may have a chamfered portion.

In examples, the projection and recess may engage by any of: a transition fit; and an interference fit.

The holder anti-rotation element may comprise a clip member configured to engage a coalescing filter element.

Each of the one or more holders may comprise a plurality of the holder anti-rotation elements.

An aspect of the disclosure provides a filter system for filtering a multiphasic fluid, wherein the multiphasic fluid comprises a first phase entrained in a second phase, the filter system comprising: a mounting assembly; wherein each of the one or more holders of the mounting assembly comprise outlets configured to provide the multiphasic fluid to a coalescing filter element engaged with the holder; a support structure, configured to hold a second an end opposite the collar of each coalescing filter element; a pressure vessel, wherein the pressure vessel comprises an interior volume configured to: contain the mounting assembly and receive the second phase from the coalescing filter element.

In examples, the mounting assembly may be an embodiment of the present disclosure.

The filter system may further comprise: one or more coalescing filter elements, wherein each of the coalescing filter elements is engaged with one of the one or more holders of the mounting assembly.

In examples, the coalescing filter elements may be an embodiment of the present disclosure.

The coalescing filter element may have a longitudinal length which is equal to the distance between the holder and the support structure of the mounting assembly.

The coalescing filter element may have an internal passage configured to receive a multiphasic fluid from the outlet of the holder, the outlet of the holder is configured to provide a multiphasic fluid to the internal passage of the coalescing filter element; and, wherein, the diameter of the internal passage is configured to interface with the outlet of the holder.

As described herein, the internal passage of the coalescing filter element may comprise an internal passage of the filter medium and an internal passage of the collar.

The diameter of the internal passage of the coalescing filter element may be less than or equal to an outer diameter of the outlet of the holder.

Advantageously, a transition or interference fit may be provided between the internal diameter of the collar of the coalescing filter element and the outlet of the holder, thereby providing an engagement between the collar and the holder. The engagement may reduce or prevent rotation and/or vibrations of the coalescing filter element relative to the holder.

An aspect of the disclosure provides use of the filter system described herein to filter a multiphasic fluid, wherein the multiphasic flow comprises a first phase entrained in a second phase.

In examples, the mounting assembly may comprise a ring of holders, wherein each holder is spaced equidistantly from its two immediate neighbouring holders. In such examples, the coalescing filter elements have a diameter to enable all of the holders to be engaged with a coalescing filter element without each coalescing filter element contacting its two immediate neighbouring coalescing filter elements engaged with the two immediate neighbouring holders.

It will be appreciated that a filter system of the present disclosure may comprise a mounting assembly of the present disclosure and as such, the mounting assembly may be considered a sub-system of the filter system. Furthermore, it will be appreciated that coalescing filter elements of the present disclosure is configured to engage a mounting assembly of the present disclosure. Therefore, the filter system, mounting assembly and coalescing filter elements of the present disclosure may be considered a plurality of interrelated products.

The second phase may be continuous and the first phase may be dispersed therein.

Herein, the terms “first phase” and “second phase” refer to two different species in the multiphasic fluid. In examples, the second phase may comprise a hydrocarbon (e.g. a hydrocarbon liquid) and the first phase may comprise water (e.g. liquid water).

Embodiments of the disclosure provide a system when displacements of a coalescing filter element relative to a typical mounting assembly which can result in a spill of the multiphasic fluid are avoided. This is advantageous because a spill of multiphasic fluid may necessitate maintenance of the filter system (and thus downtime of the filter system) and loss of the multiphasic fluid, both of which are undesirable, because they may be financially costly.

Vibrations in the filter system may cause the coalescing filter elements to vibrate relative to the mounting assembly (e.g. periodic displacements and/or rotations of the coalescing filter element relative to the mounting assembly). Embodiments of the present disclosure advantageously prevent or reduce such vibrations.

Herein a filter element comprises a filter media. The filter media may be configured to separate a first phase from a second phase wherein the first phase is dispersed in the second phase.

Herein the filter element may have a cylindrical shape.

The term “length”, L, of a filter element, may refer to the effective length of the filter media. For example, the filter media of the filter element may have an effective filter area. The effective filter area may be defined as the portion of the filter medium configured to filter fluid e.g. the portion of the filter medium which is not disposed in an endcap of the filter element. In examples, the effective filter area may have a cylindrical shape. The longitudinal length of the effective filter area may be referred to as the length L e.g. the effective length of the filter element.

Herein the term “diameter”, D, of a filter element, may refer to the internal diameter of the filter element e.g. the smallest diameter of an internal passage of the filter element (e.g. wherein the internal passage is delimited by the filter media). In examples wherein the filter element comprises pleated filter media, the diameter may refer to the smallest diameter of the filter media e.g. a diameter starting from a most radially inward pleat of the filter media to another part of the filter media.

The length of the filter element may be the same as the distance between a holder and a lobe e.g. wherein the holder and the lobe are configured to engage a single filter element. In examples, the length of the filter element may be 490 mm. In examples, the distance between a holder and a lobe may be 490 mm.

The diameter may be 102 mm. The diameter may be 150 mm. The diameter may be any distance between and including 102 mm and 150 mm, preferably, the diameter may be 110 mm.

### DRAWINGS

Embodiments of the disclosure will now be described, by way of example only, with reference to the accompanying drawings, in which:

FIG. 2 illustrates a perspective view of a mounting assembly of a filter system for filing multiphasic fluid wherein a plurality of coalescing filter elements are installed in the mounting assembly;

FIG. 3 illustrates a perspective view of a holder of the mounting assembly of illustrated in FIG. 2;

FIG. 4A illustrates a perspective cut-away view of a coalescing filter element engaged with the holder shown in FIG. 3;

FIG. 4B illustrates an enhanced view of the interface between the coalescing filter element and the holder shown in FIG. 4A;

FIG. 5A illustrates a perspective view of a collar anti-rotation element;

FIG. 5B illustrates a perspective view of a holder anti-rotation element.

FIG. 6 illustrates a graph showing the relationship between the maldistribution percentage of the multiphasic fluid in a coalescing filter element and a length to diameter ratio (L/D) of the coalescing filter element;

### SPECIFIC DESCRIPTION

The present disclosure relates to coalescing filter elements for a filter system for filtering a multiphasic fluid, wherein the filter system comprises a mounting assembly and one or more coalescing filter element. The one or more coalescing filter elements is configured to engage the mounting assembly. The disclosure provides means for preventing or reducing at least one of: rotation of the coalescing relative to the mounting assembly; and, vibration of the coalescing filter element relative to the mounting assembly.

FIG. 1 illustrates a cross-sectional view of a filter element 100. The filter element 100 comprises: a filter medium 108; a collar 110; a collar anti-rotation element 150 (shown in FIGS. 3A and 3B); and, an internal passage 170.

In the example shown in FIG. 1, the filter element may comprise an optional flow straightener 250

The internal passage is configured to receive a multiphasic fluid (e.g. a gas with liquid entrained therein). The direction of flow of multiphasic fluid entering the internal passage is depicted by arrow E.

The filter medium 108 is configured to filter a multiphasic fluid (e.g. a first phase entrained in a second phase). In examples, the multiphasic fluid may comprise fluids from processes gas. The filter medium 108 is configured to filter (e.g. separate and remove) the first phase from the second phase e.g. to filter a liquid entrained in a gas. The multiphasic fluid passes through the filter medium (e.g. from the internal passage 170 to an exterior of the filter element) which results in the multiphasic fluid being filtered by the filter medium. The multiphasic fluid passes from the interior passage 170 to an exterior of the filter element in a radially outward direction depicted by arrow F.

The flow straightener 250 is configured to improve flow (e.g. improve flow distribution) through the filter element 120 e.g. the flow through the internal passage 170. For example the flow straightener 250 may linearize the multiphasic fluid flow therethrough e.g. the flow straightener 250 may reduce or remove vorticity from the multiphasic fluid flow which passes therethrough.

The flow straightener 250 is disposed in the filter element 120 so that any gas entering the internal passage 170 passes through the flow straightener 250. In particular, the flow straightener 250 is disposed “upstream” of internal passage 170 such that gas passes through the flow straightener 250 before entering the internal passage 170.

The internal passage 170 comprises a diameter D. The diameter D may refer to the smallest diameter of the internal passage. The length L of the filter medium 108 may refer to the total longitudinal length of the filter element through which a fluid flow may exit the internal passage of the filter element.

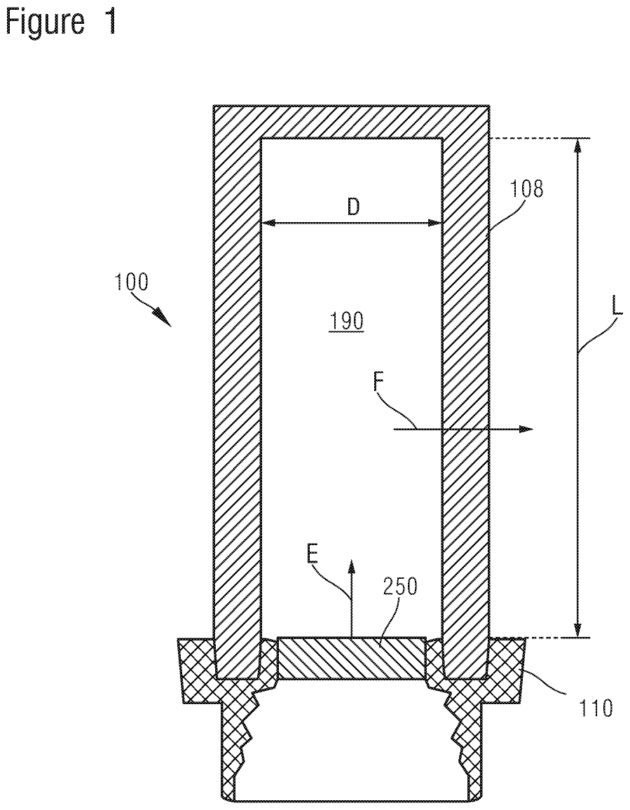

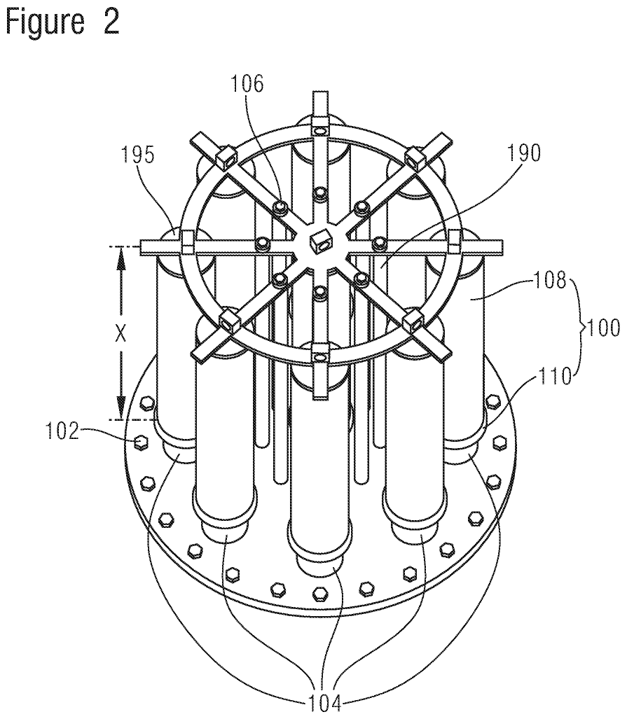

FIG. 2 illustrates a perspective view of a mounting assembly of a filter system for filtering multiphasic fluid wherein a plurality of coalescing filter elements is installed in the mounting assembly.

The filter system comprises: a mounting assembly; and, a pressure vessel (not shown in the drawings).

The mounting assembly is disposed within the pressure vessel. In the filter system the mounting assembly and coalescing filter elements are disposed in the pressure vessel.

The mounting assembly comprises; a base plate 102; a plurality of holders 104; a support structure 106; and, a set of rods 190.

The support structure is held spaced apart from the base plate 102 by the set of rods 190. The support structure comprises a plurality of lobes 195. Each of the plurality of holders 104 is disposed on the base plate 102 so that a coalescing filter element can be fitted between each of the holders and the each of the lobes 195 of the support structure 106. In the example shown, the lobes 195 are disposed directly opposite one of the holders 104 e.g. a straight line perpendicular to the base plate intersects a holder and a lobe. A separation distance X is defined as the shortest distance between a holder 104 and the end of the support structure 106.

Each of the holders comprises an outlet configured to provide a multiphasic fluid to the internal passage of each of the coalescing filter elements (shown in FIG. 2).

The mounting assembly forms part of a filter system. The filter system is configured for filtering a multiphasic fluid, wherein the multiphasic fluid comprises a first phase entrained in a second phase.

Each of the coalescing filter 120 elements comprises: a filter medium 108; a collar 110; a collar anti-rotation element 150 (shown in FIGS. 3A and 3B); and, an internal passage 170 (shown in FIGS. 3A and 3B).

The filter elements are cylinders. A collar is disposed at the end of each cylinder to assist in support of the filter medium in the predefined shape e.g. a cylinder. The coalescing filter elements are hollow e.g. the coalescing filter

The filter medium 108 has a cylindrical shape. The filter medium 108 defines a part of an internal passage of the coalescing filter element. The collar 110 defines another part of the internal passage of the coalescing filter element. For example, in other words, both the filter medium and the collar may comprise their own respective internal passages which are in fluid communication with one another. The coalescing filter element internal passage is thereby provided by the combination of the filter medium internal passage and the collar internal passage The collar 110 comprises: a collar anti-rotation element; and, a drain for permitting exit of a first phase of a multiphasic fluid.

The filter medium 108 is connected to the collar 110. In the example shown in FIG. 1, the filter medium 108 is fixedly attached to the collar 110. In examples wherein the filter medium 108 is fixedly attached to the collar 110, movement of the collar 110 (e.g. a rotation) results in an identical movement to the filter medium 108 (e.g. the filter medium rotates in the same direction by the same amount).

The collar 110 is configured to hold the filter medium in a predefined shape. In the present example, the collar is configured to hold the filter medium in a cylindrical shape. In a corresponding manner, the holders 104 of the present example have an annular shape.

Each of the coalescing filter elements 120 has a longitudinal length equal to a separation distance X. That is, the coalescing filter elements 120 are sized to fit between a holder and the end of the support structure.

Each of the plurality of coalescing filter elements 120 is installed in the mounting assembly. Each of the plurality of coalescing filter elements is connected to one of the holders. The collar 110 of each of the coalescing filter elements 120 is connected to a holder 104. Each collar 110 comprises a collar anti-rotation element configured to engage the annular holder thereby to prevent or reduce at least one of: (a) rotation of the collar relative to the holder; and, (b) vibration of the collar relative to the holder.

Example collar anti-rotation elements include: a projection; a recess; a projection and a recess; and, a clip. Collar anti-rotation elements are described in more detail herein. The collar anti-rotation element of a coalescing filter element may be configured to engage a holder to maintain a rotational position of the coalescing filter element relative to the holder.

Each of the plurality of coalescing filter elements 120 is connected to part of the end of the support structure 106 e.g. the end of each of the coalescing filter elements opposite the collar 110 is connected to a lobe 195.

The filter medium 108 is configured to coalesce particles of the first phase to provide coalesced particles comprising the first phase to enable separation of the coalesced particles from the second phase.

In examples, the filter medium 108 may comprise one or more filter stages. The one or more filter stages may comprise: a material configured for coalescing hydrophobic fluids (e.g. the material is hydrophobic); a material configured for coalescing hydrophilic fluids (e.g. the material is hydrophilic). In examples, the filter medium may comprise a porous material. In examples wherein the filter medium comprises more than one filter stage, a first filter stage (the filter stage closer to the internal passage than any other filter stage) may have a first mean pore size. the second filter stage (the filter stage which is second closest to the internal passage) may have a second mean pore size, wherein the second mean pore size is greater than the first mean pore size. In like manner successive filter stages may have successively greater mean pore sizes. Advantageously, particles of the first phase increase in mean size as they pass through the successive filter stages of successively greater mean pore size.

In examples, the distance between a lobe and a holder (e.g. wherein the lobe and holder are configured to engage the same filter element) may be 490 mm or the distance may be slightly bigger (on the order of millimetres) in order to facilitate fitting of the filter element in between the lobe and holder. In such examples, the filter elements may have a maximum length of 490 mm. The filter elements may have any length less than or equal to 490 mm. Advantageously, increasing the length L of the filter element increases the total surface area of the filter available for filtering a multiphasic fluid (e.g. the throughput of the filter element is increased). Therefore, it is advantageous to provide a filter element with a L equal to (or just less than to allow for fitting) the distance between the lobe and holder. In the example shown in FIG. 2, the filter elements may have a length L of 250 mm or more preferably 300 mm, or more preferably 350 mm, or more preferably a length of 400 mm, or more preferably of 450 mm, or more preferably of 470 mm, or more preferably of 480 mm, or more preferably of 485 mm, or more preferably of 490 mm.

In examples, it is advantageous to provide a filter element with a length L less than or equal to the distance between the lobe and the holder minus the longitudinal length of an end cap of the filter element.

Our investigations have found that a filter element with an L/D ratio of between 3.0 and 6.0 may improve separation efficiency and/or may reduce maldistribution of the multiphasic fluid in use. Our investigations have found that a filter element with an L/D ratio of between 3.2 and 4.8 may further improve separation efficiency and/or may further reduce maldistribution of the multiphasic fluid in use. Our investigations have found that a filter element with an L/D ratio of between 3.5 and 5.1 may further improve separation efficiency and/or may further reduce maldistribution of the multiphasic fluid in use.

A L/D ratio between 3.2 and 4.8 is especially effective with a gaseous hydrocarbon (e.g. such as any of: methane, ethane, butane, benzene) with a liquid phase of water and/or one or more liquified hydrocarbons (e.g. such as any of: methane, ethane, butane, benzene) entrained therein. In examples, the gaseous hydrocarbon and the liquid phase may comprise the same hydrocarbon, for example, the gaseous hydrocarbon may comprise methane and the liquid phase may comprise methane.

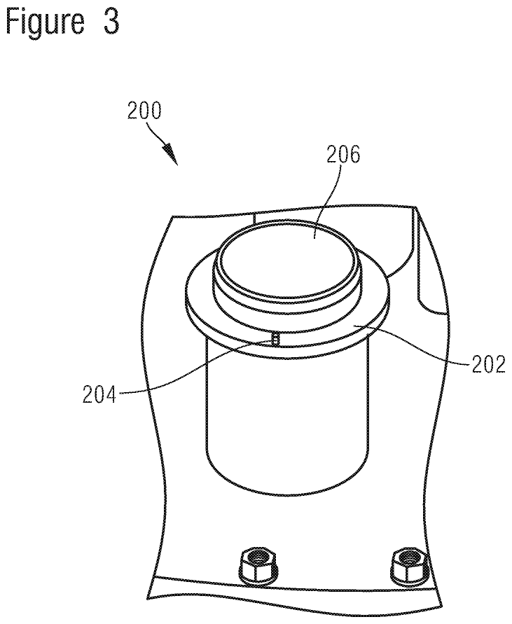

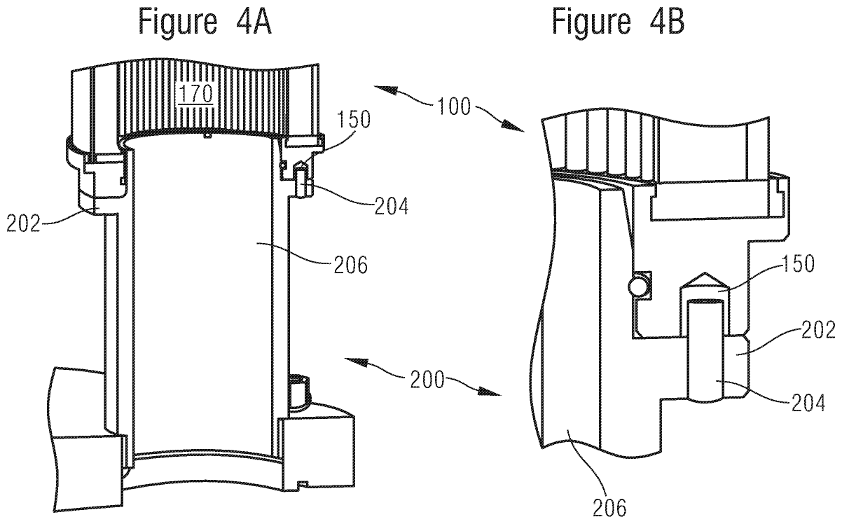

FIG. 3 illustrates a perspective view of a holder 200 of the mounting assembly of illustrated in FIG. 1; FIG. 4A illustrates a perspective cut-away view of a coalescing filter element engaged with the holder shown in FIG. 3; FIG. 4B illustrates an enhanced view of the interface between the coalescing filter element and the holder shown in FIG. 4A.

The holder 200 comprises: a bezel 202; a holder anti-rotation element 204, and, an outlet 206.

The holder anti-rotation 204 element is disposed on the bezel 202. The bezel 202 surrounds the outlet 206.

In addition to the other features set out above, the coalescing filter element 100 comprises: a collar anti-rotation element 150; and, an internal passage 170.

The bezel 202 is configured to support a coalescing filter element disposed on the holder 200. In the example shown, the bezel 202 provides a platform upon which the collar of the coalescing filter element may sit.

The holder anti-rotation element 204 is configured to engage a collar anti-rotation element of a coalescing filter element e.g. the holder anti-rotation element 204 corresponds to the collar anti-rotation element. In the example shown, the collar anti-rotation element will be a recess and the projection comprising the holder anti-rotation element is configured to engage the recess.

The outlet 206 is configured to provide multiphasic fluid to a coalescing filter element disposed on the holder. The outlet 206 is configured to provide multiphasic fluid to an internal passage of a coalescing filter element disposed on the holder. The coalescing filter element is configured to coalesce particles of the first phase to provide coalesced particles comprising the first phase to enable separation of the coalesced particles from the second phase.

The collar anti-rotation element 150 is configured to engage the holder (in the present example, the holder anti-rotation element 204) by longitudinal movement of the coalescing filter element 100 toward the holder 200. In the present example, the collar anti-rotation element 150 is a recess and the holder comprises a holder anti-rotation element 204 comprising a projection wherein the recess is configured to receive the projection (e.g. the recess is large enough to receive the projection). When the recess and projection are aligned in a longitudinal direction, longitudinal movement of the coalescing filter element toward the holder will result in the recess receiving the projection.

The coalescing filter element 100 and the holder are described as being in an engaged configuration (e.g. an engaged position) when the collar anti-rotation element prevents or reduces rotation and/or vibrations of the coalescing filter element relative to the holder. In the present example, the coalescing filter element and the holder are in an engaged configuration when the recess (e.g. the collar anti-rotation element) receives the projection (e.g. the holder anti-rotation element).

When the projection is received within the recess (and, therefore, the coalescing filter element and the holder are in an engaged configuration) rotation of the coalescing filter element, about the longitudinal axis, relative to the holder is inhibited. Such rotation is inhibited by the projection acting on the recess.

In some examples, as that one shown in FIG. 2, the outlet 206 projects in a longitudinal direction from the bezel 202. When a coalescing filter element is installed on the holder, the outlet 206 may project into the internal passage of the coalescing filter element. Advantageously, this may provide an adequate seal to prevent leakage of multiphasic fluid from the interface between the coalescing filter element and the holder.

In examples, the coalescing filter element may be sized so that the diameter of the internal passage forms a transition/interference fit with the outlet e.g. the internal passage engages the outlet to prevent or reduce rotation and/or vibration of the coalescing filter element. In such examples, the collar anti-rotation element may be considered the internal passage and the corresponding part of the holder (e.g. the holder anti-rotation element) may be considered the outlet.

The disclosure also provides other arrangements which include alternative anti-rotation features.

In examples, the collar anti-rotation element may comprise a projection and the holder may comprise a corresponding element e.g. a recess.

In examples, the collar anti-rotation element may comprise both a recess and a projection and the holder anti-rotation element may comprise a corresponding element e.g. a projection and a recess. An example of such an arrangement is shown in FIG. 4.

In examples, the collar anti-rotation element may comprise a clip and the holder may comprise a corresponding element e.g. the bezel of the holder. In more detail, the holder may comprise a bezel and an outlet as shown in FIG. 2 but may omit the holder anti-rotation element (the projection) shown in FIG. 2. The clip may be configured to grasp the bezel. For example, the coalescing filter element may configured to engage the holder by means of axial motion of the cylindrical coalescing filter element towards the annular holder. In other words, the clip may be configured to engage (e.g. grasp) the bezel as the coalescing filter is pushed towards the holder, for example, in the manner of a snap-fit.

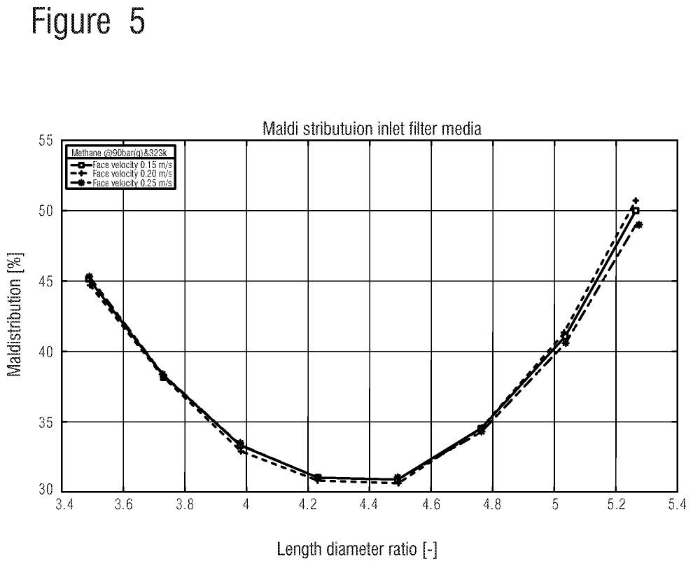

FIG. 5A illustrates a perspective view of a collar anti-rotation element 310; and, FIG. 5B illustrates a perspective view of a holder anti-rotation element 320.

The collar anti-rotation element 310 comprises: a collar recess 302; and, a collar projection 304.

The collar recess has a square cross-sectional shape (e.g. when viewed in a longitudinal direction). The collar projection has a circular cross-sectional shape (e.g. when viewed in a longitudinal direction).

The collar recess 302 surrounds the collar projection 304.

The holder anti-rotation element 320 comprises: a holder projection 306; and, a holder recess 308.

The holder projection has a square cross-sectional shape (e.g. when viewed in a longitudinal direction). The holder recess has a circular cross-sectional shape (e.g. when viewed in a longitudinal direction).

The holder projection 306 surrounds the holder recess 308.

The collar projection 304 is configured to be received by the holder recess 308. The collar recess 302 is configured to receive the holder projection 306. For example, the respective projections may be received by the respective recesses by means of longitudinal movement of the collar (and coalescing filter element) toward the holder.

When both the collar projection 304 and the holder projection 306 are received respectively by the holder recess 308 and the collar recess 302, the collar is engaged with the holder (e.g. in an engaged configuration).

We have surprisingly found that in the example shown in FIGS. 4A and 4B, the circle cross-sectional shape may have a greater efficacy at preventing/reducing vibrations than the square cross-sectional shape and the square cross-sectional shape may have a greater efficacy at preventing/reducing such rotations than the circle cross-sectional shape.

In examples wherein the collar anti-rotation element comprises both a recess and a projection, the torque on the projection of the collar anti-rotation element may be reduced because there is also projection of the holder anti-rotation element which may act to spread the torsion and or strain applied to the system.

In examples, the collar recess may be separate from the collar projection e.g. the collar recess may not surround the collar projection. In such examples, the holder projection may be separate from the holder recess e.g. the holder projection may not surround the holder recess.

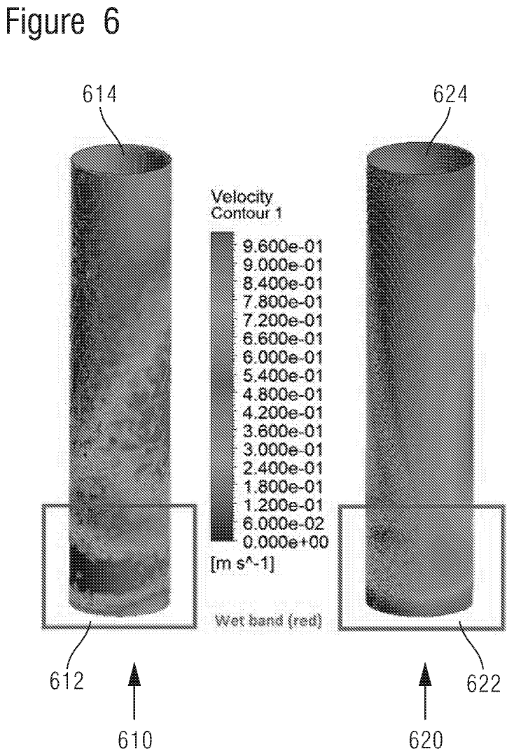

FIG. 6 illustrates a graph showing the relationship between the maldistribution percentage of the multiphasic fluid in a coalescing filter element and an length to diameter ratio (L/D) of the coalescing filter element;

The inventors of the present application performed a number of computer simulations to determine the relationship between: maldistribution of multiphasic fluid passing through a filter element; and, the ratio between a coalescing filter elements length and diameter (referred to as a “length-diameter ratio”). Simulations were performed on a number of different length-diameter ratios at a number of different face velocities of the flow. The results of the simulations are set shown in FIG. 5.

FIG. 5 comprises: an x-axis, labelled length-diameter ratio (no units); a y-axis, labelled maldistribution (%). Plotted relative to the axes are: a set of points representing fluid passed through coalescing filter elements at a face velocity of 0.15 m/s (star symbol); a set of points representing fluid passed through coalescing filter elements at a face velocity of 0.20 m/s (cross symbol); and, a set of points representing fluid passed through coalescing filter elements at a face velocity of 0.25 m/s (square symbol).

The set of points in each set are sequentially connected by a straight-line to give an approximately parabolic shape (e.g. a U-shape) referred to hereinafter as a “curve”. Each curve corresponding to each set of points is approximately coincident, that is, each curve is approximately superimposed on top of the others.

The curves each have a minimum maldistribution of around 31% at a length-diameter ratio of around 4.4.

The curves have a maldistribution of 45% or less when the length-diameter ratio is between around 3.5 and 5.1.

Providing a coalescing filter element with a length to diameter ration between around 3.5 and 5.1 results in the coalescing filter element wherein maldistribution of multiphasic fluid passing through the filter element (in use) is less than or equal to 45%.

Providing a coalescing filter element with a maldistribution less than or equal to 45% results in a coalescing filter element which is more efficient (e.g. filters more multiphasic fluid per second) than a coalescing filter element with a maldistribution greater than 45%.

Computational Fluid Dynamics (CFD) simulations were performed to determine L/D ratios of filter elements which provide improved filtration of a multiphasic fluid and improve separation efficiency. The CFD simulations involved simulating a filter element with a given L/D ratio, and simulating the flow of multiphasic fluid through the simulated filter element.

The simulated filter elements comprise a central passage delimited by an inner cylindrical surface. Notionally, the inner cylindrical surface is a cylindrical shell located at the filter media.

FIG. 6 illustrates the inner cylindrical surface 610 of a first simulated filter element and the inner cylindrical surface 620 of a second simulated filter element.

FIG. 6 illustrates the first area 610. The first inner cylindrical surface 610 has a cylindrical shape with a first axial end 612 and a second axial end 614. FIG. 6 illustrates the second inner cylindrical surface 620. The second inner cylindrical surface 620 has a cylindrical shape with a first axial end 622 and a second axial end 624.

The simulation has a fluid (e.g. gas) flow which enters a first end of the first simulated filter element which corresponds to the first end 612 of the first inner cylindrical surface 610. The simulation has a fluid (e.g. gas) flow which enters a first end of the second simulated filter element which corresponds to the first end 622 of the second inner cylindrical surface 620.

This corresponds to an estimate of the speed of flow through the filter element.

On each of inner cylindrical surfaces 610 and 620, the magnitude of the velocity of the fluid flow at a given position through the surface is indicated at that position. In other words, each of the surfaces 610 and 620 displays the magnitude of the velocity of simulated fluid passing through each point of the surface e.g. FIG. 6 illustrates two scalar fields each indicative of the magnitude of a simulated fluid flow passing through the surface of a simulated filter element wherein the magnitude of the velocity of the simulated fluid is a function of position on the surface. The software used to generate the simulated filter element normalizes the velocity magnitude of fluid which is simulated passing through the simulated filter element by reference to the maximum simulated velocity through the simulated surface.

The first inner cylindrical surface 610 illustrates the local velocity magnitude in a filter element with a non-optimal L/D ratio e.g. the an L/D ratio outside the range of 3.5 and 5.1. The first inner cylindrical surface 610 has a high velocity magnitude at the first end 612 shown by circumferential band of high velocity close to first end 612 which may be referred to as a “wet band”. The velocity magnitude elsewhere on the first area 610 (i.e. not in the “wet band”) is less than the velocity magnitude of fluid in the “wet band”. Therefore, first inner cylindrical surface 610 displays a wide range of velocity magnitudes. In the example shown by area 610 in FIG. 6 the range of velocity magnitudes are normalized by reference to the maximum velocity through each of the simulated surfaces.

A wide range of local velocity magnitudes in a filter element are indicative of maldistribution. A first phase (e.g. liquid) which is removed from a second phase (e.g. a gas flow). A wide range of local velocity magnitudes may result in a first phase (e.g. a liquid) accumulating at points where the velocity magnitude is greatest in the first inner cylindrical surface 610. At points whereat the first phase accumulates, there is an increased likelihood that the first phase will be become re-entrained in the second phase. Therefore, reducing the range of local velocity magnitudes may improve separation efficiency and/or increase the amount of first phase removed from the second phase.

The second inner cylindrical surface 620 illustrates the local velocity magnitudes in a filter element with an optimal L/D ratio e.g. the an L/D ratio inside the range of 3.5 and 5.1. The first inner cylindrical surface has a local velocity magnitudes which are approximately equal across the first inner cylindrical surface. The range of local velocity magnitudes is approximately zero. As the range of local velocity magnitudes is approximately (e.g. very close to) zero the second inner cylindrical surface 620 has negligible maldistribution and, therefore, no “wet band” forms.

FIG. 6 illustrates that optimizing the L/D ratio (e.g. setting an L/D ratio between 3.5 and 5.1 or an L/D ratio between 3.2 and 4.8) may reduce the range of local velocity magnitudes. Reducing local velocity differences in a filter element may increase the efficiency of the filter element (e.g. re-entrainment of liquid in a gas flow may be reduced, therefore, improving separation of the liquid phase from the gas phase).

As will be appreciated by the skilled reader in the context of the present disclosure, each of the examples described herein may be implemented in a variety of different ways. Any feature of any aspects of the disclosure may be combined with any of the other aspects of the disclosure. For example, method aspects may be combined with apparatus aspects, and features described with reference to the operation of particular elements of apparatus may be provided in methods which do not use those particular types of apparatus. In addition, each of the features of each of the embodiments is intended to be separable from the features which it is described in combination with, unless it is expressly stated that some other feature is essential to its operation. Each of these separable features may of course be combined with any of the other features of the embodiment in which it is described, or with any of the other features or combination of features of any of the other embodiments described herein. Furthermore, equivalents and modifications not described above may also be employed without departing from the invention.

In the examples wherein the filter elements are arranged as shown in FIG. 2, and the distance between a lobe and holder is 490 mm there is a lower limit on the L/D ratio of 3.2 e.g. the diameter of the filter elements can be no greater than 150 mm. If the diameter were increased beyond this value (i.e. if the L/D ratio were decreased below 3.2) then adjacent filter elements could not be disposed on adjacent holders because the outer surface of the filter elements would collide/interfere.

In the examples wherein the filter elements are arranged as shown in FIG. 2, and the distance between a lobe and holder is 490 mm there is an upper limit on the L/D ratio of 4.8 e.g. the diameter of the filter elements can be no less than 102 mm. If the diameter were decreased beyond this value (i.e. if the L/D ratio were increased above 4.8) then the throughput of fluid through the filter elements would be insufficient for their intended purpose. For example, filter elements with an L/D ratio above 4.8 may have a high pressure drop across of the filter element, thereby resulting in a reduction in efficiency of the filter element.

1. A coalescing filter element configured for installation into a filter system for filtering a multiphasic fluid, wherein the multiphasic fluid comprises a first phase entrained in a second phase, wherein the coalescing filter element comprises:
a filter medium configured to:
coalesce particles of the first phase to provide coalesced particles comprising the first phase to enable separation of the coalesced particles from the second phase;
a collar connected to the filter medium, wherein the collar is configured to:
hold the filter medium in a predefined shape; and,
engage with an annular holder of a mounting assembly of the filter system to permit installation of the coalescing filter element into the filter system;
wherein the collar comprises:
a collar anti-rotation element configured to engage the annular holder thereby to prevent or reduce at least one of: (a) rotation of the collar relative to the holder; and, (b) vibration of the collar relative to the holder.

2. The coalescing filter element of claim 1, wherein:
the collar anti-rotation element is configured to hold the filter medium in a predefined rotational position with respect to the holder when the coalescing filter element is installed in the filter system.

3. The coalescing filter element of any of the preceding claims, wherein:
the predefined shape is a cylinder having a longitudinal axis; and,
the collar anti-rotation element is configured to engage the holder by longitudinal movement of the coalescing filter element toward the holder wherein the collar anti-rotation element once engaged with the collar thereby inhibits rotation of the coalescing filter element about the longitudinal axis.

4. The coalescing filter element of any of the preceding claims, comprising:
an L/D ratio, defined as the diameter of the internal passage divided the longitudinal length of the coalescing filter element, wherein the L/D ratio is between 3.5 and 5.1.

5. The coalescing filter element of any of the preceding claims, wherein:
an internal passage of the collar and an outlet of the holder are configured engage by means of an interference fit or a transition fit between the internal passage and the outlet of the holder.

6. The coalescing filter element of any of the preceding claims, wherein: in use, a predominantly lateral flow of the multiphasic fluid is provided through the filter medium, which exerts one of: a lateral force; and, torsional force on the coalescing filter element; and, the wherein collar anti-rotational element configured to engage the holder to resist said force.

7. The coalescing filter element of any of the preceding claims, wherein:
the collar anti-rotation element comprises at least one of:
a projection and a recess configured to engage with a corresponding complementary element of the holder.

8. The coalescing filter element of claim 7, wherein:
the projection has a tapered portion.

9. The coalescing filter element of any of claims 7 to 8, wherein,
the projection and recess engage by any of: a transition fit; and an interference fit.

10. The coalescing filter element of any of claims 7 to 9, wherein:
the recess comprises a chamfered aperture.

11. The coalescing filter element of any of claims 1 to 10, wherein,
the collar anti-rotation element comprises a clip member configured to engage the holder.

12. The coalescing filter element of any of the preceding claims, further comprising:
a plurality of the collar anti-rotation elements.

13. The coalescing filter element of any of claims 1 to 3 and 5 to 12, comprising:
an L/D ratio, defined as the diameter of the internal passage divided the longitudinal length of the coalescing filter element, wherein the L/D ratio is between 3.2 and 4.8.

14. A mounting assembly of a filter system for filtering a multiphasic fluid, the filter system configured to permit installation of a coalescing filter element therein, wherein the multiphasic fluid comprises a first phase entrained in a second phase, wherein the mounting assembly comprises:
one or more holders, wherein each of the one or more holders is configured to:
engage a collar of a coalescing filter element to thereby prevent rotation of the coalescing filter element relative to a holder.

15. The mounting assembly of claim 14, wherein:
the one or more holders comprises a holder anti-rotation element configured to hold the filter medium in a predefined rotational position with respect to the holder when the coalescing filter element is installed on the mounting assembly.

16. The mounting assembly of any of claims 14 to 15, wherein:
the one or more holders are each configured to engage a coalescing filter element, wherein the coalescing filter element comprises:
a filter medium with a cylindrical shape and a collar with an annular shape, wherein the filter medium and the collar share a longitudinal axis; and,
the one or more holders are configured to engage the coalescing filter element by longitudinal movement of the coalescing filter element toward the one or more holders to install the coalescing filter element on the one or more holders.

17. The mounting assembly of any of claims 14 to 16, wherein:
in use, a predominantly lateral flow of the multiphasic fluid is provided, via the one or more holders, through the filter medium of the coalescing filter element, which exerts one of: a lateral force; and, torsional force on the coalescing filter element; and, the wherein collar anti-rotational element configured to engage the holder to resist said force.

18. The mounting assembly of any of claims 14 to 17, wherein:
each holder anti-rotation element comprises at least one of:
a projection and a recess configured to engage a corresponding collar anti-rotation element.

19. The mounting assembly of claim 18, wherein:
the projection is tapered

20. The mounting assembly of any of claims 14 to 19, wherein,
the projection and recess engage by any of: a transition fit; and an interference fit.

21. The mounting assembly of any of claims 14 to 20, wherein,
the holder anti-rotation element comprises a clip member configured to engage a coalescing filter element.

22. The mounting assembly of any claims 14 to 21, wherein:
each of the one or more holders comprises a plurality of the holder anti-rotation elements.

23. A filter system for filtering a multiphasic fluid, wherein the multiphasic fluid comprises a first phase entrained in a second phase, the filter system comprising:
the mounting assembly of any of claims 14 to 22;
wherein each of the one or more holders of the mounting assembly comprise outlets configured to provide the multiphasic fluid to a coalescing filter element engaged with the holder;
a support structure, configured to hold a second an end opposite the collar of each coalescing filter element;
a pressure vessel, wherein the pressure vessel comprises an interior volume configured to:
contain the mounting assembly
receive the second phase from the coalescing filter element.

24. The filter system of claim 23, the filter system further comprising:
one or more coalescing filter elements according to any of claims 1 to 13, wherein each of the coalescing filter elements is engaged with one of the one or more holders of the mounting assembly.

25. The filter system of any of claims 23 to 24, wherein:
the coalescing filter element has a longitudinal length which is equal to the distance between the holder and the support structure of the mounting assembly.

26. The filter system of any of claims 23 to 25, wherein:
the coalescing filter element has an internal passage configured to receive a multiphasic fluid from the outlet of the holder, the outlet of the holder is configured to provide a multiphasic fluid to the internal passage of the coalescing filter element; and, wherein, the diameter of the internal passage is configured to interface with the outlet of the holder.

27. The filter system of claim 26, wherein:
the diameter of the internal passage of the coalescing filter element is equal to an outer diameter of the outlet of the holder.

28. Use of the filter system of claim 27 to filter a multiphasic fluid, wherein the multiphasic flow comprises a first phase entrained in a second phase.
